(19) United States
(12) Patent Application Publication
(10) Pub. No.: US 2024/0157831 A1
(43) Pub. Date: May 16, 2024

(54) CHARGING CONTROL DEVICE

(71) Applicant: TOYOTA JIDOSHA KABUSHIKI KAISHA, Toyota-shi (JP)

(72) Inventor: Kenji NAKAMURE, Susono-shi (JP)

(73) Assignee: TOYOTA JIDOSHA KABUSHIKI KAISHA, Toyota-shi (JP)

(21) Appl. No.: 18/371,752

(22) Filed: Sep. 22, 2023

(30) Foreign Application Priority Data
Nov. 11, 2022 (JP) 2022-180814

(51) Int. Cl. B60L 53/60; B60L 53/302; B60L 58/26; B60L 58/27

(52) U.S. Cl. CPC B60L 53/60; B60L 53/302; B60L 58/26; B60L 58/27

(57) ABSTRACT

A charging control device includes: a contact-type automatic charger arranged under a floor and having an opening that opens to an outer surface of a vehicle body; a protective cover that opens and closes the opening; a cooling water circuit that cools at least one of an internal combustion engine prime mover or an electric unit; and a heating unit that is provided on a high water temperature path of the cooling water circuit and heats the contact-type automatic charger.

### CROSS-REFERENCE TO RELATED APPLICATION(S)

The present application claims priority to and incorporates by reference the entire contents of Japanese Patent Application No. 2022-180814 filed in Japan on Nov. 11, 2022.

### BACKGROUND

The present disclosure relates to a charging control device.

Japanese Laid-open Patent Publication No. 2016-088251 discloses a technology in which a heater that generates heat by energization from a driving battery mounted on a vehicle is provided inside a charging inlet for manual charging. In this technology, the heater heats a protective cover that protects an opening of the charging inlet, whereby sticking of the protective cover to the opening of the charging inlet due to freezing is prevented.

### SUMMARY

There is a need for providing a charging control device capable of preventing, without consuming electric power of a driving battery, a protective cover from being frozen and stuck to an opening.

According to an embodiment, a charging control device includes: a contact-type automatic charger arranged under a floor and having an opening that opens to an outer surface of a vehicle body; a protective cover that opens and closes the opening; a cooling water circuit that cools at least one of an internal combustion engine prime mover or an electric unit; and a heating unit that is provided on a high water temperature path of the cooling water circuit and heats the contact-type automatic charger.

### BRIEF DESCRIPTION OF THE DRAWINGS

FIG. 1 is a cross-sectional view schematically illustrating a main part of a vehicle according to a first embodiment of the present disclosure;

FIG. 2 is a flowchart illustrating an outline of processing executed by an ECU according to the first embodiment of the present disclosure;

FIG. 3 is another cross-sectional view schematically illustrating the main part of the vehicle according to the first embodiment of the present disclosure; and

FIG. 4 is a cross-sectional view schematically illustrating a main part of a vehicle according to a second embodiment of the present disclosure.

### DETAILED DESCRIPTION

In the related art, in Japanese Laid-open Patent Publication No. 2016-088251, since electric power of a driving battery mounted on a vehicle is consumed when a charging cover is frozen, there is a problem that a heater cannot be operated in a case where a state of charge (SOC) of the driving battery is lowered.

Hereinafter, a charging control device according to embodiments of the present disclosure will be described with reference to the drawings. Note that the present disclosure is not limited to the following embodiments. In the following description, the same portions are denoted by the same reference numerals.

### First Embodiment

Configuration of a Vehicle

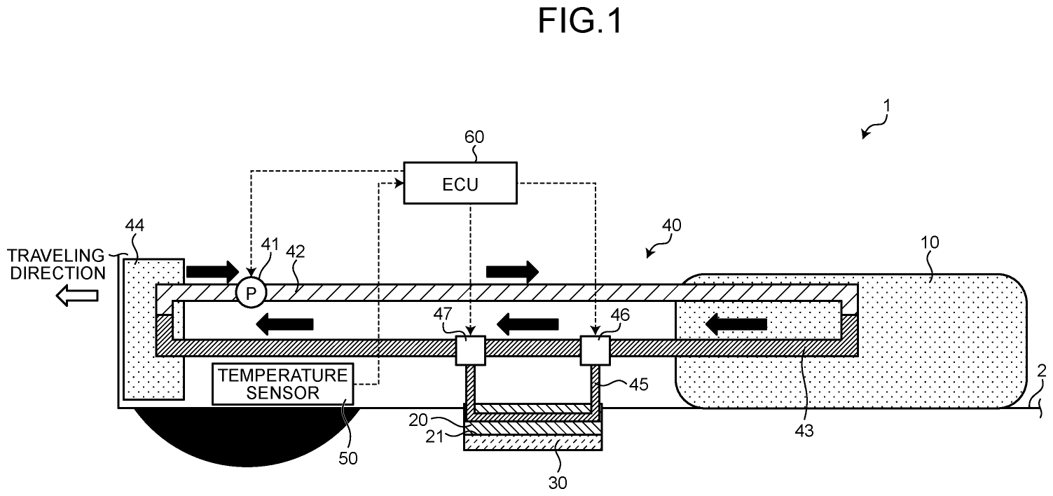

FIG. 1 is a cross-sectional view schematically illustrating a main part of a vehicle according to the first embodiment of the present disclosure. A vehicle 1 illustrated in FIG. 1 is assumed to be a battery electric vehicle (BEV), a plug-in hybrid electric vehicle (PHEV), or the like.

The vehicle 1 includes a driving unit 10, a contact-type automatic charger 20, a protective cover 30, a cooling water circuit 40, a temperature sensor 50, and an electronic control unit (ECU) 60. Note that in the first embodiment, the contact-type automatic charger 20, the protective cover 30, the cooling water circuit 40, the temperature sensor 50, and the ECU 60 function as a charging control device.

The driving unit 10 is configured by utilization of at least one of an internal combustion engine prime mover such as an engine, or an electric unit, and drives the vehicle 1. The electric unit includes a driving battery, a power converter, a motor, and the like. The driving battery is electrically connected to the contact-type automatic charger 20 via a transmission path (not illustrated). The driving battery is supplied with power from the outside via the contact-type automatic charger 20.

The contact-type automatic charger 20 is arranged under a floor of the vehicle 1 and has an opening 21 that opens to an outer surface of a vehicle body 2 of the vehicle 1. The contact-type automatic charger 20 includes a power receiving coil, an AC/DC converter, a rectification unit, and the like. The contact-type automatic charger 20 receives power from a power transmission coil arranged on a ground side by contact power feeding or non-contact power feeding by an electromagnetic induction system or a magnetic field resonance system, and supplies the received power to the driving battery. Note that in the first embodiment, the contact-type automatic charger 20 functions as a charging inlet.

The protective cover 30 is provided to be movable in a front-back direction of the vehicle 1, and opens and closes the opening 21 of the contact-type automatic charger 20. Specifically, the protective cover 30 moves in the front-back direction of the vehicle 1 under the control of the ECU 60 and changes the opening 21 of the contact-type automatic charger 20 from an open state to a closed state or from the closed state to the open state.

The cooling water circuit 40 cools the driving unit 10 with cooling water flowing inside. The cooling water circuit 40 includes an electric water pump 41, a cooling water passage 42, a hot water passage 43, a radiator 44, a bypass path 45, and changeover switches 46 and 47.

The electric water pump 41 discharges cooling water to the cooling water passage 42 and circulates the cooling water in a circulation path including the cooling water passage 42, the hot water passage 43, and the radiator 44.

One side of the cooling water passage 42 is connected to the radiator 44, and the other side thereof is connected to the driving unit 10. The cooling water passage 42 cools the driving unit 10 by delivering, to the driving unit 10, the cooling water discharged from the electric water pump 41.

One side of the hot water passage 43 is connected to the driving unit 10, and the other side thereof is connected to the radiator 44. The hot water passage 43 delivers hot water heated by the driving unit 10 to the radiator 44.

The cooling water passage 42 and the hot water passage 43 are connected to the radiator 44. The radiator 44 cools the hot water delivered from the hot water passage 43 with outside air, and delivers the cooled cooling water to the cooling water passage 42.

The bypass path 45 is provided on the hot water passage 43 on a high water temperature path of the cooling water circuit 40. The bypass path 45 heats the contact-type automatic charger 20 with the hot water heated by the driving unit 10. Specifically, the bypass path 45 passes through a part of the contact-type automatic charger 20, the hot water for cooling waste heat of the cooling water circuit 40 flowing therein. As a result, the bypass path 45 indirectly heats the contact-type automatic charger 20. Note that the bypass path 45 functions as a heating unit in the first embodiment.

The changeover switches 46 and 47 are provided between the hot water passage 43 and the bypass path 45, and causes a part of the hot water flowing through the hot water passage 43 to flow into the bypass path 45. The changeover switches 46 and 47 switch inflow destinations of the hot water under the control of the ECU 60. The changeover switches 46 and 47 are configured by utilization of a passage changeover valve or the like.

The temperature sensor 50 detects a temperature outside the vehicle 1 and outputs a result of the detection to the ECU 60.

The ECU 60 is realized by utilization of a processor having hardware. A hard disk is, for example, a memory, a central processing unit (CPU), a digital signal processor (DSP), a field-programmable gate array (FPGA), a graphics processing unit (GPU), or the like. The ECU 60 controls the changeover switches 46 and 47 on the basis of the result of the detection by the temperature sensor 50. Specifically, the ECU 60 causes the hot water flowing through the hot water passage 43 to be supplied to the bypass path 45 by controlling the changeover switches 46 and 47.

Processing by the ECU

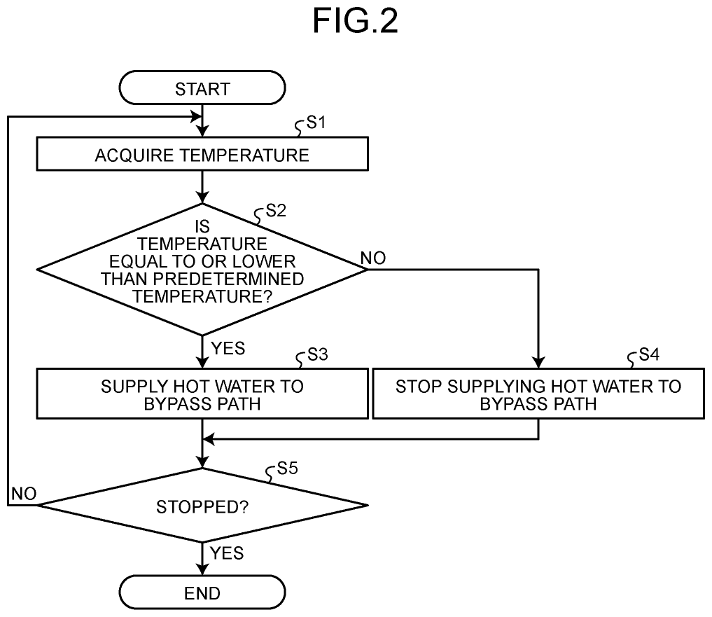

Next, processing executed by the ECU 60 will be described. FIG. 2 is a flowchart illustrating an outline of the processing executed by the ECU 60.

As illustrated in FIG. 2, the ECU 60 acquires a current temperature from the temperature sensor 50 (Step S1).

The ECU 60 determines whether the temperature acquired from the temperature sensor 50 is equal to or lower than a predetermined temperature (Step S2). Here, the predetermined temperature is, for example, a temperature at which the protective cover 30 is frozen in the contact-type automatic charger 20 and the protective cover 30 cannot be opened, and is below freezing (0 degrees or lower), for example. In a case of determining that the temperature acquired from the temperature sensor 50 is equal to or lower than the predetermined temperature (Step S2: Yes), the ECU 60 proceeds to Step S3. On the other hand, in a case where it is determined that the temperature acquired from the temperature sensor 50 is not equal to or lower than the predetermined temperature (Step S2: No), the ECU 60 proceeds to Step S4.

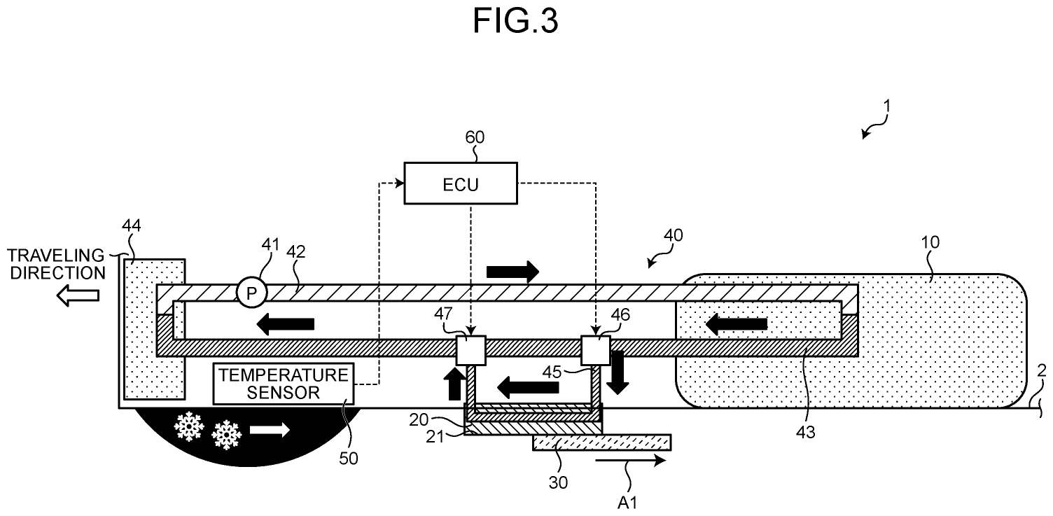

In Step S3, the ECU 60 causes the hot water flowing through the hot water passage 43 to be supplied to the bypass path 45 by controlling the changeover switches 46 and 47. Thus, as illustrated in FIG. 3, the cooling water heated by the driving unit 10 flows into the bypass path 45 as the hot water. As a result, since the contact-type automatic charger 20 and the protective cover 30 are heated by the bypass path 45, it is possible to prevent the protective cover 30 from being frozen and stuck to the contact-type automatic charger 20. As a result, as indicated by an arrow A1 in FIG. 3, the protective cover 30 can move in the front-back direction even when an outside temperature is below freezing. After Step S3, the ECU 60 proceeds to Step S5.

In Step S4, the ECU 60 stops the supply of the hot water to the bypass path 45 by controlling the changeover switches 46 and 47. Specifically, the ECU 60 controls the changeover switches 46 and 47 and stops the hot water in the hot water passage 43 from flowing into the bypass path 45. After Step S4, the ECU 60 proceeds to Step S5.

In Step S5, the ECU 60 determines whether an instruction signal for stopping the vehicle 1 is input from an ignition switch (not illustrated). In a case where the instruction signal for stopping the vehicle 1 is input from the ignition switch (Step S5: Yes), the ECU 60 ends the present processing. On the other hand, in a case where the instruction signal for stopping the vehicle 1 is not input from the ignition switch (Step S5: No), the ECU 60 returns to Step S1.

According to the first embodiment described above, the ECU 60 causes the hot water flowing through the hot water passage 43 to be supplied to the bypass path 45 by controlling the changeover switches 46 and 47, whereby the cooling water heated by the driving unit 10 flows into the bypass path 45 as the hot water. As a result, since the contact-type automatic charger 20 and the protective cover 30 are heated by the bypass path 45, it is possible to prevent the protective cover 30 from being frozen and stuck to the opening 21 of the contact-type automatic charger 20.

In addition, in the first embodiment, since the protective cover 30 is heated by the bypass path 45 with the hot water heated by the driving unit 10, consumption of the driving battery can be prevented.

Furthermore, in the first embodiment, even when the driving battery has a low SOC, the opening 21 of the contact-type automatic charger 20 can be made open, whereby the vehicle 1 can be charged.

Furthermore, in the embodiment, it is possible to charge the vehicle 1 at a low temperature without consuming or reducing a life of an auxiliary battery of the internal combustion engine prime mover of the driving unit 10.

### Second Embodiment

Next, the second embodiment will be described. A vehicle according to the second embodiment has a similar configuration as that of the first embodiment except that a configuration of a cooling water circuit is different from the configuration of the cooling water circuit 40 according to the first embodiment. In the following description, the same components are denoted by the same reference signs, and a detailed description thereof will be omitted.

Configuration of a Vehicle

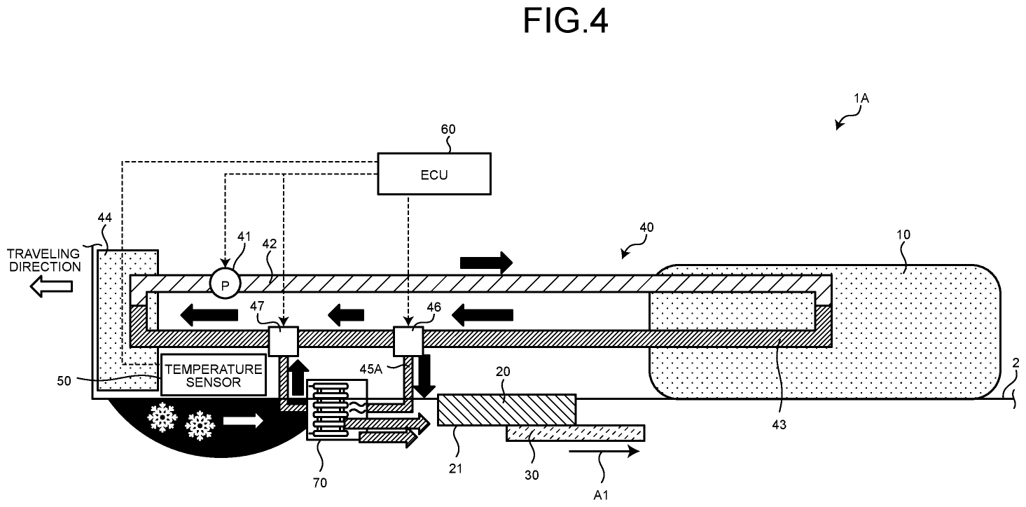

FIG. 4 is a cross-sectional view schematically illustrating a main part of the vehicle according to the second embodiment of the present disclosure. A vehicle 1A illustrated in FIG. 4 includes a cooling water circuit 40A instead of the cooling water circuit 40 according to the first embodiment.

The cooling water circuit 40A cools a driving unit 10 with cooling water flowing inside. The cooling water circuit 40A includes an electric water pump 41, a cooling water passage 42, a hot water passage 43, a radiator 44, a bypass path 45A, changeover switches 46 and 47, and a heat exchanger 70.

The bypass path 45A is provided on the hot water passage 43 on a high water temperature path of the cooling water circuit 40. Furthermore, the bypass path 45A is provided on a front side of a vehicle 1A compared to a contact-type automatic charger 20. Hot water for cooling waste heat of the cooling water circuit 40A heated by the driving unit 10 flows into the bypass path 45A through the hot water passage 43 and the changeover switch 46.

The heat exchanger 70 is provided in the bypass path 45A. Specifically, the heat exchanger 70 is provided in the bypass path 45A on the front side of the vehicle 1A compared to the contact-type automatic charger 20. The heat exchanger 70 exchanges heat between cold air of outside air and the hot water in the bypass path 45A and delivers warm air to the protective cover 30. As a result, the heat exchanger 70 heats the contact-type automatic charger 20. Note that in the second embodiment, the heat exchanger 70 functions as a heating unit.

In the vehicle 1A configured in such a manner, similarly to the first embodiment, the ECU 60 controls the changeover switches 46 and 47 according to a temperature acquired from a temperature sensor 50, and causes the hot water to flow from the hot water passage 43 into the bypass path 45A. As a result, the heat exchanger 70 exchanges heat between the cold air of the outside air and the hot water in the bypass path 45A and delivers the warm air to the protective cover 30. As a result, the contact-type automatic charger 20 and the protective cover 30 are heated by the heat exchanger 70. As a result, the protective cover 30 is prevented from being frozen and stuck to the contact-type automatic charger 20. Thus, the protective cover 30 can move in a front-back direction as indicated by an arrow A1 in FIG. 4.

According to the second embodiment described above, the heat exchanger 70 exchanges heat between the cold air of the outside air and the hot water in the bypass path 45A and delivers the warm air to the protective cover 30. As a result, since the contact-type automatic charger 20 and the protective cover 30 are heated by the heat exchanger 70, it is possible to prevent the protective cover 30 from being frozen and stuck to the contact-type automatic charger 20.

### Other Embodiments

Note that in the description of the flowchart in the present description, although the expressions such as “first”, “then”, “subsequently”, and “finally” are used to clarify processing order of the steps, the processing order required to carry out the present embodiment is not defined uniquely by these expressions. That is, the processing order in the flowchart described in the present description can be changed within a range without contradiction.

Further effects and modification examples can be easily derived by those skilled in the art. Broader aspects of the present disclosure are not limited by the specific details and representative embodiments that are illustrated and described in the above manner. Thus, various modifications can be made without departing from the sprit or scope of a general concept of the disclosure defined by the accompanying claims and an equivalent thereof.

Although some of embodiments of the present application have been described in detail with reference to the drawings, these are merely examples. In addition to the aspects described in the disclosure of the present disclosure, the present disclosure can be implemented in other forms on which various modifications and improvements are performed on the basis of knowledge of those skilled in the art.

According to the present disclosure, it is possible to prevent freezing of a protective cover of a charging inlet without consuming power of a driving battery.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A charging control device comprising:
a contact-type automatic charger arranged under a floor and having an opening that opens to an outer surface of a vehicle body;
a protective cover that opens and closes the opening;
a cooling water circuit that cools at least one of an internal combustion engine prime mover or an electric unit; and
a heating unit that is provided on a high water temperature path of the cooling water circuit and heats the contact-type automatic charger.

2. The charging control device according to claim 1, wherein
the heating unit includes
a bypass path which passes through a part of the contact-type automatic charger and in which hot water for cooling waste heat of the cooling water circuit flows.

3. The charging control device according to claim 1, wherein
the heating unit includes
a bypass path which is provided on a front side of the vehicle body compared to the contact-type automatic charger and in which hot water for cooling waste heat of the cooling water circuit flows, and
a heat exchanger that is provided in the bypass path, exchanges heat between outside air and hot water in the bypass path, and delivers warm air to the protective cover.

4. The charging control device according to claim 3, further comprising
a temperature sensor that detects temperature,
a changeover switch that is provided between a hot water passage in the cooling water circuit and the bypass path and causes a part of the hot water to flow in the bypass path, and
a processor that controls the changeover switch on a basis of a result of the detection of the temperature sensor.
